(19) United States
(12) Patent Application Publication
(10) Pub. No.: US 2009/0219525 A1
(43) Pub. Date: Sep. 3, 2009

(54) SYSTEM AND METHOD FOR PORTABLE RAMAN SPECTROSCOPY

(75) Inventors: Matthew S. Marcus, Plymouth, MN (US); Bernard S. Fritz, Eagan, MN (US); Tzu-Yu Wang, Maple Grove, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/040,843

(22) Filed: Feb. 29, 2008

(51) Int. Cl. G01J 3/44

(52) U.S. Cl. 356/301

(57) ABSTRACT

One embodiment includes a method that includes scanning a plurality of specimens with a laser by moving the laser according to coordinates for laser movement and measuring a distance for each of the plurality of specimens, associating location information with each of the specimens of the plurality of specimens based on its distance from the laser and its coordinates for laser movement, recording a Raman spectrum for the plurality of specimens, associating a Raman spectrum with each specimen of the plurality of specimens and indicating a Raman spectrum and location information for at least one specimen.

### BACKGROUND

Raman spectroscopy is useful for analyzing matter. There is a need to make Raman spectrometers portable so that they are more useful in existing applications, and so that they can be used in new applications.

### BRIEF DESCRIPTION OF THE DRAWINGS

FIG. 1A illustrates a scanning Raman spectrometer, according to some embodiments.

FIG. 1B illustrates the scanning Raman spectrometer of FIG. 1B in a different mode.

FIG. 2 illustrates a Raman spectrometer, according to some embodiments.

FIG. 3 illustrates a display for a Raman spectrometer, according to some embodiments.

FIG. 4 illustrates a scanning spectrometer and coordinates for scanning, according to some embodiments.

FIG. 5 illustrates a method, according to some embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

It is desired to remotely detect the chemical composition of solids, liquids, and gasses. Specific applications that benefit from remote chemical detection include, but are not limited to, tailpipe and smoke-stack emission analysis, petrochemical gas leaks, liquid chemical spills, drug detection, puddles and hazardous material detection, CO₂ detection in vehicles crossing international borders, airport scanning such as automatic airport scanning, etc. Various entities such as by the Department of Defense of the United States, or the Department of Homeland Security of the United States could use the present subject matter.

In various embodiments, the present subject matter uses an optical method to detect the molecular composition of remote specimens. Examples of specimens include, but are not limited to, a solid object, a gas cloud and a liquid puddle. Various embodiments report a molecular composition via a spectrometer that is part of a detector. Additional embodiments report a higher-level composition (e.g., petroleum, plant matter, narcotics, etc.) via determining constituents to the higher-level composition.

In some examples, the components necessary to perform analysis are integrated into a small form factor that is portable. The portable detector can be used in a “point and shoot” mode in some embodiments to detect an object at a fixed specific location. In additional embodiment, the detector can be used in a scanning mode where the chemical composition of a large area can be determined and optionally mapped as chemical composition as a function of spatial coordinate. Various embodiments include a spectrometer coupled to a scanning mechanism to position the housing in alignment with a plurality of specimens. Non-portable scanners are additionally possible, such as scanners permanently installed at an airport or at another place.

Optical detection methods include, but are not limited to, active infrared (“IR”) absorption, passive IR absorption, laser induced fluorescence (“LIF”) detection, and Raman detection. Passive and active IR techniques detect the chemical composition of liquids and gasses over kilometer distances, in various embodiments. This ability is enabled by the high sensitivity of infrared absorption. While IR techniques offer a solution for long range gas and liquids detection, the associated costs can be expensive.

Active IR absorption provides a solution having reduced cost for chemical composition detection at a range over one or more meters. Active IR absorption schemes typically require a back-reflecting surface, such as a tree, the ground, or a wall. Embodiments of the present subject matter relying on Raman spectroscopy do not require a back-reflecting surface since the Raman mechanism uses non-directional scattered light.

In various embodiments, laser induced fluorescence (“LIF”) provides a means for remotely detecting the chemical composition of objects. However, the sensitivity of LIF can be limited because the light emitted from the chemical(s) of interest is typically at a single wavelength. This limited detection channel can be a source of false positives. In contrast, embodiment of the present subject matter relying on Raman spectroscopy monitor scattered light comprised of several wavelengths.

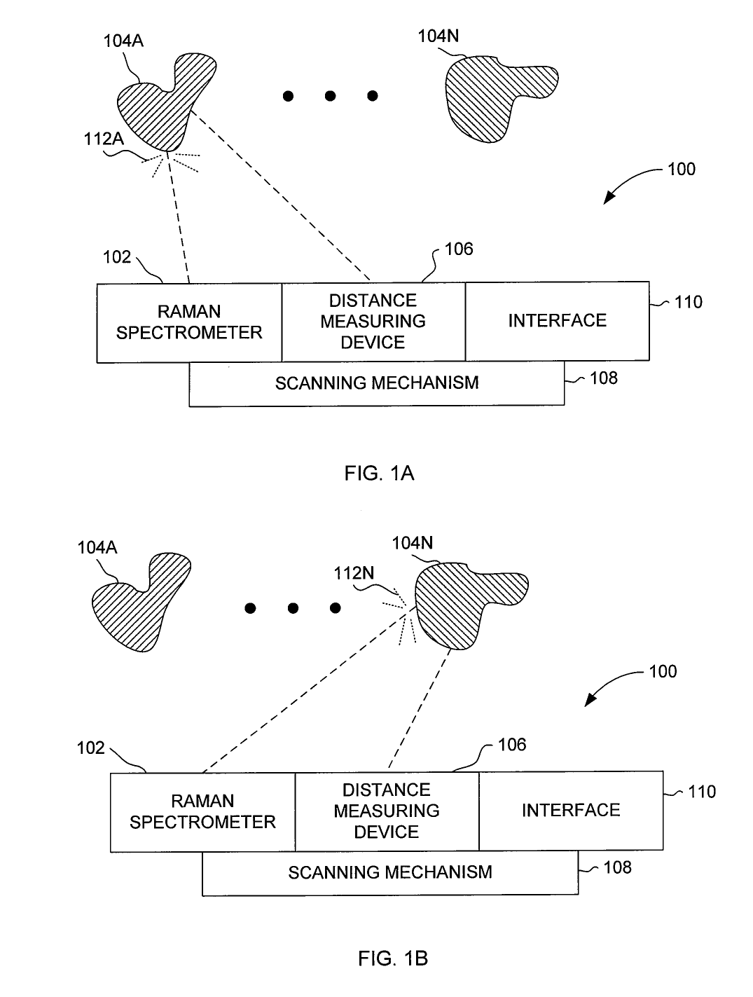

FIGS. 1A-B illustrates a detector 100 that scans, according to some embodiments. According to several examples, the detector 100 includes one of several spectrometers disclosed herein. In some embodiments, the detector 100 includes a Raman spectrometer 102 as disclosed herein. In various embodiments, the Raman spectrometer 102 measures a Raman spectrum of at least one of the specimens 104A-N. Some embodiments of the detector 100 include a distance measuring device 106. In various embodiments, the distance measuring device 106 is mechanically coupled to the Raman spectrometer 102, such as via a housing or a circuit board. In some embodiments, the distance measuring device 106 optically determines distance to at least one specimen of the specimens 104A-N. Means for measuring distance include, but are not limited to, measuring with a graduated counter such as a ruler or a vehicle odometer, sound, such as via sonar, and optically, such as via a range-finding laser, including range finding lasers that measure time of flight, multiple frequency phase-shift and/or interferometery. The location of one of the specimens 104A-N can be determined, in various embodiments, by using the distance to the specimen as discussed herein.

Various embodiments include a scanning mechanism 108. In various embodiments, the scanning mechanism 108 is coupled to the Raman spectrometer 102 to align the Raman spectrometer 102 and the distance measuring device 106 with each of the specimens 104A-N. The scanning mechanism 108 includes a gimbal, in various embodiments, but the present subject matter is not so limited.

Various embodiments include an interface 110. In various embodiments, the interface 110 displays a location and a Raman spectrum for at least one specimen of the specimens 104A-N. An interface 110 can output a signal carrying information, in some embodiments, via wires, optics, or wirelessly. In some embodiments, the interface includes a display. Displays contemplated include, but are not limited to, screens including touch screens, text bars, indicator lights, mechanical flags, and other displays.

In various embodiments, a photodetector is coupled to the Raman spectrometer 102 such that an image of the specimens is formed. In some of these embodiments, the interface indicates the location of one of the specimens 104A-N, the Raman spectrum for that specimen, and a picture of that specimen via the photodetector. Some embodiments draw a virtual line in the display between the detector and the specimen of interest.

In various examples, light from the Raman spectrometer 102 is incident upon a one of the specimens 104A-N. In various embodiments, scattered light 112A-N is transmitted back to the detector 100 and detected, such as by optics of the detector 100 and by other detecting components. Raman spectroscopy inelastically scatters light using an illumination source, such as a laser. The scattered light is shifted in wavelength based on the unique vibrational properties of the molecules that make up the specimen. Recording the intensity and wavelength of the scattered light can provide an identification of the unknown substance. According to various embodiments, the optical path of the focusing lenses is varied in order to illuminate and collect light at different distances. In various embodiments, components of a detector are arranged to fit into a small form factor, such as the size of a backpack, so that it can be carried by a person. Embodiments which are large and are permanently fixed to a structure such as a building are additionally possible.

According to various embodiments, a housing houses several components of the detector 100. In various embodiment, the housing houses a battery to power a spectrometer, a distance measuring transceiver, a scanning mechanism and an interface, with the spectrometer, the distance measuring device, and the battery each disposed in the housing. In some embodiments, the housing includes a seal such that the housing is submersible in water.

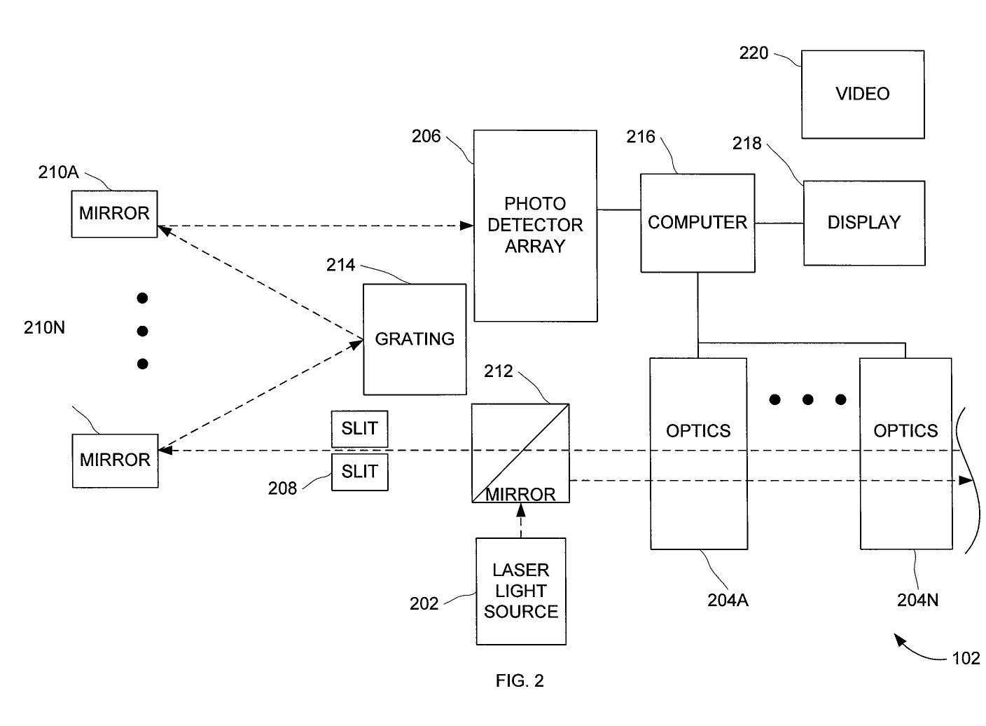

FIG. 2 illustrates a Raman spectrometer 102, according to some embodiments. In various embodiments, the portable Raman detector includes a laser light source 202. Examples of laser light sources include, but are not limited to, infrared lasers, ultraviolet lasers, and other lasers. In some embodiments, the laser light source 202 doubles as a range finding laser. Various embodiments include a range finding laser coupled to the Raman spectrometer to optically determine distance to the at least one specimen. Visible lasers for the range finger are used in some embodiments to encourage accurate aiming as well as eye safety. These are useful to encourage aiming and eye safety in embodiments in which the laser used to evoke Raman scatter is not visible.

Various embodiments of the spectrometer 102 include a photo-detector array 206. In various embodiments, the photo-detector array 206 detects Raman scattering, but the present subject matter is not so limited. Examples of photo-detector arrays to detect Raman scattering include, but are not limited to, charge-coupled devices (“CCD”).

In various embodiments, the spectrometer 102 includes optics 204A-N. Optics add functionality including, but not limited to, focusing laser light and collecting laser light such as Raman scattered light. Various embodiments include a slit 208 coupled to the laser light source 202 and aligned with the path of the laser. Various embodiments include one or more mirrors 210A-N. It is indicated that several mirrors can be used as the present subject matter is not limited to the particular configuration illustrated. Other systems and geometries are possible without departing from the present subject matter. Some embodiments include a beam splitter 212 that can direct light in two directions. Various embodiments include a grating 214 aligned with the path of the laser. A dispersive grating is used in various embodiments. Various embodiments include a collimating lens aligned with the laser path of the laser.

Various embodiments include a computer 216. In various examples, the computer 216 interprets a signal from the photo-detector array 206. In some embodiments, the computer 216 controls one or more mechanisms of the spectrometer, such as the optics 204A-N. In some examples, the computer controls the laser light source 202 to provide Raman excitation light in a first mode, and range finding and distance measuring in a second mode.

Various embodiments include an interface 218 to display a location and a Raman spectrum for at least one specimen. Some embodiments include a housing and a battery to power the Raman spectrometer, the range finding laser, and the interface, with the Raman spectrometer, the distance measuring device, and the battery each disposed in the housing. Some embodiments include a composition information circuit coupled to Raman spectrometer to associate the Raman spectrum with a specified composition. This circuit can be part of the computer 216, the interface 218 or another subsystem of the spectrometer 102. The interface 218 coupled with computer 216 can be used to not only display images and Raman spectra, but also provide an interface where a user can control the optics 204A-N, the laser light source 202, the slit 208 and the photo-detector array 206.

Some embodiments include a video recorder 220 that records photographs or videos. Data captured by the video record 220 can include the visible spectrum, but the present subject matter is not so limited. In various embodiments, the images captured by the video recorder 220 are associated with one or more recorded spectra or locations.

In various embodiments, the detector 102 is computer controlled via the computer 216. In various embodiments, the computer 216 is autonomous. In some examples, the computer 216 measures one or more specimens in order to improve a Raman measurement to yield an improved signal to noise ratio (S/N). In one example, the computer 216 monitors the output of the photo-detector array 206 at the wavelength of the excitation laser light source 202 while controlling the optics 204A-N. In various embodiments, the output of the photo-detector array 206 is improved by controlling the optics 204A-N. In other examples, the computer automatically improves the output of the photo-detector at the laser excitation wavelength by controlling the parameters or operation of any combination of the of the components that comprise the detector 102, including the optics 204A-N, the power of the laser light source 202, the slit width 208 or the integration time of the photo-detector array.

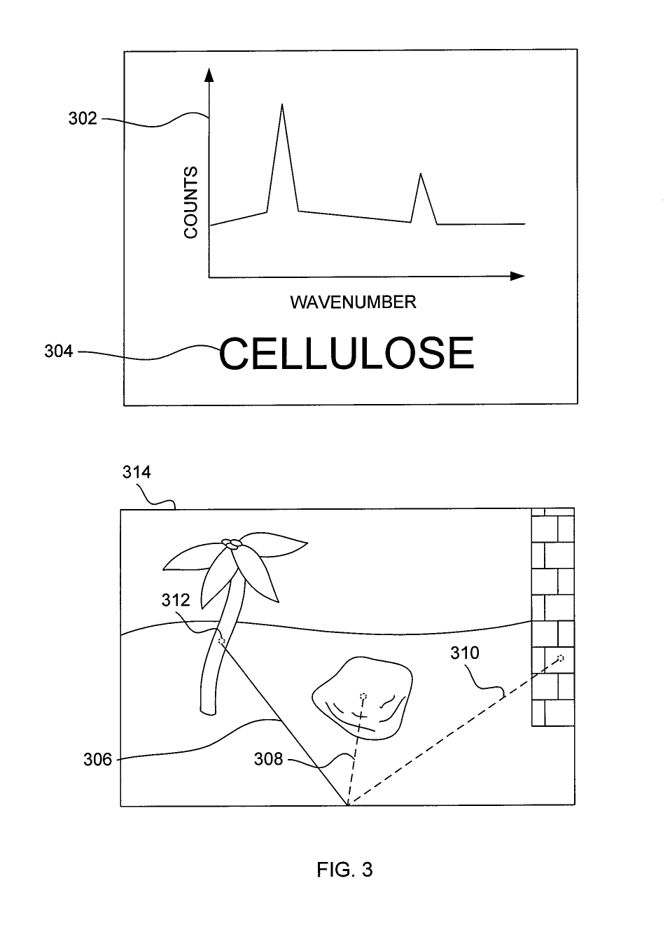

FIG. 3 illustrates a display for a Raman spectrometer, according to some embodiments. In various embodiments, the display includes an example wave diagram 302 with counts on the y-axis and wave number on the x-axis (e.g., cm⁻¹). The example wave diagram 302 is not based on real data and is provided for explanatory purposes. In various embodiments, the intensity of backscattered light is measured, and the focus adjusts optics or other computers to find a signal maxima. The maximized signal of interest includes the Rayleigh scattered light at the wavelength of the excitation source as described above, in various embodiments. Such auto-focusing can be part of a computer or an interface, according to several embodiments. Embodiments that use manual focus are additionally possible.

Some embodiments include a text display 304 that is the result of interpretation of the measured waveform and comparison of the waveform with a specified waveform to determine a higher-level composition. The text display 304 could also display more specific molecular information, such as hydrogen sulfide, benzene, etc.

Various embodiments include a picture display 314. The illustrated picture display 314 shows a tree, a rock, and a brick structure. The illustration shows that a laser path 306 has been directed toward the tree. It could optionally be directed 308 toward a rock, or directed 310 toward a brick structure. The optional paths may or may not be shown in the display according to various embodiments. In some embodiments, a user can touch the picture illustration to select a specimen. The illustration shows that a small scan of each specimen, such as the small scan 312, has been made to determine a wave number according to a statistical approach, such as by average. Although the small scan is showing, an instant sample with one laser path is additionally possible, as are larger scan paths.

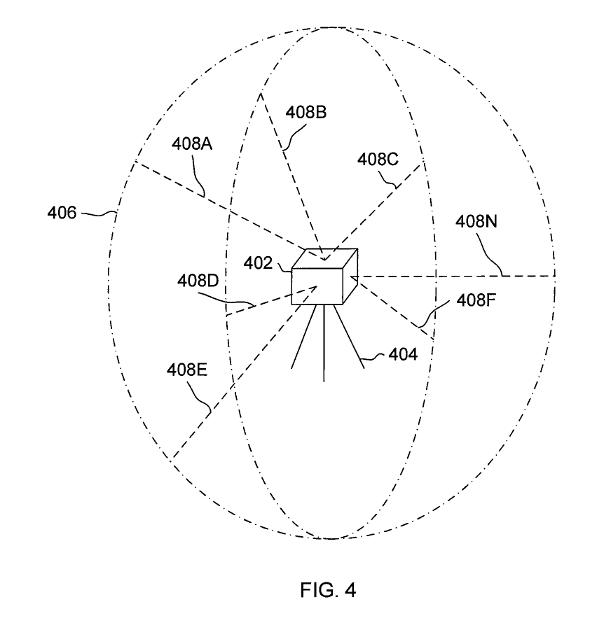

FIG. 4 illustrates a scanning spectrometer and coordinates for scanning, according to some embodiments. In various embodiments, a detector 402 can be used in a point and shoot mode by pointing at a specimen and then shooting the specimen and recording a Raman spectrum. This can be aided by a visible laser, in some examples. Although the detector 402 is illustrated resting on a tri-pod 404, the present subject matter is not so limited, and other mounts, such as robot and vehicle mounts are possible. Portable detectors are used in some embodiments for detector 402.

In additional embodiments, a scan mode is used, scanning according to coordinates 406. Examples of possible coordinates include, but are not limited to, Cartesian, cylindrical, spherical or semi-spherical coordinate scanning scheme. In various embodiments, a detector is adjusted, such as by controlling a motor such as a stepper motor, to different positions such that the head is aligned with a specified coordinate system. The illustration shows spherical coordinates. For example, a series of measurements could be made 0 degrees from an equator, then 5 degrees along a latitude of the equator, the 5 degrees along the latitude and 5 degrees from a longitude, etc. Recording a plurality of measurements of specimens according to a coordinate system allows for mapping of the specimens, so long as distance information relating to the specimens is known. For example, a computer can combine coordinate information with distance information to obtain a three dimensional location for a specimen that can then be mapped.

Along a coordinate path, multiple measurements 408A-N can be made. The present subject matter includes embodiments in which samples are also collected randomly while moving a detector 402 in a scanning mode. In various embodiments, a scanning mode rotates the detector 402 and adjusts the focus and collection distance automatically. In various embodiments, distance to the specimen is sensed while scanning. In some embodiments, a map is constructed from the collected data and displays chemical composition as a function of spatial coordinate. Embodiments which provide for remote control, such as from a guard post, are additionally possible. Remote control can include activation/deactivation, aiming, and control of scanning modes, among other adjustments.

According to several embodiments, the point and shoot measurement mode uses a fixed distance and position to measure a specific target. In some examples, it is advantageous to use an ultraviolet (“UV”) wavelength laser for spectroscopy. In various examples, a UV laser increases the sensitivity of the measurement compared to visible and IR based technology. In some embodiment, sensitivity is increased because the Raman scattering cross section is larger at UV wavelengths compared to longer wavelengths. In some examples, using a UV laser increases the measurement sensitivity since the noise is reduced as a result of lower background radiation from the sun compared to other wavelengths. An additional benefit of using a UV laser is that a high power excitation beam can be used while remaining safe for the human eye.

In various embodiments, each measurement collects photons that are Raman scattered from the chemical target of interest. The data, or spectrum indicated includes photon counts as a function of wavelength shift from the excitation laser. The unique spectrum obtained can be compared to a data library to identify the chemical target of interest.

Each collected photon counts towards a measurable signal which competes with noise throughout the system. In various embodiments, a measurement is indicated as successful if the ratio of signal to noise (“S/N”) is above a specified threshold. In some examples, a successful measurement has S/N greater than or equal to 3, but the present subject matter is not so limited. In order to improve S/N, the detector 402 can automatically direct itself, such as toward a specimen having a higher concentration and volume of the target composition. The system can additionally vary power of the measurement laser, focus optics configuration, distance from the chemical target, measurement time (a.k.a. integration time), and slit width. In various embodiments, noise is determined by details of the measurement electronics, background light from the sun, and in certain scenarios, the strength of the signal.

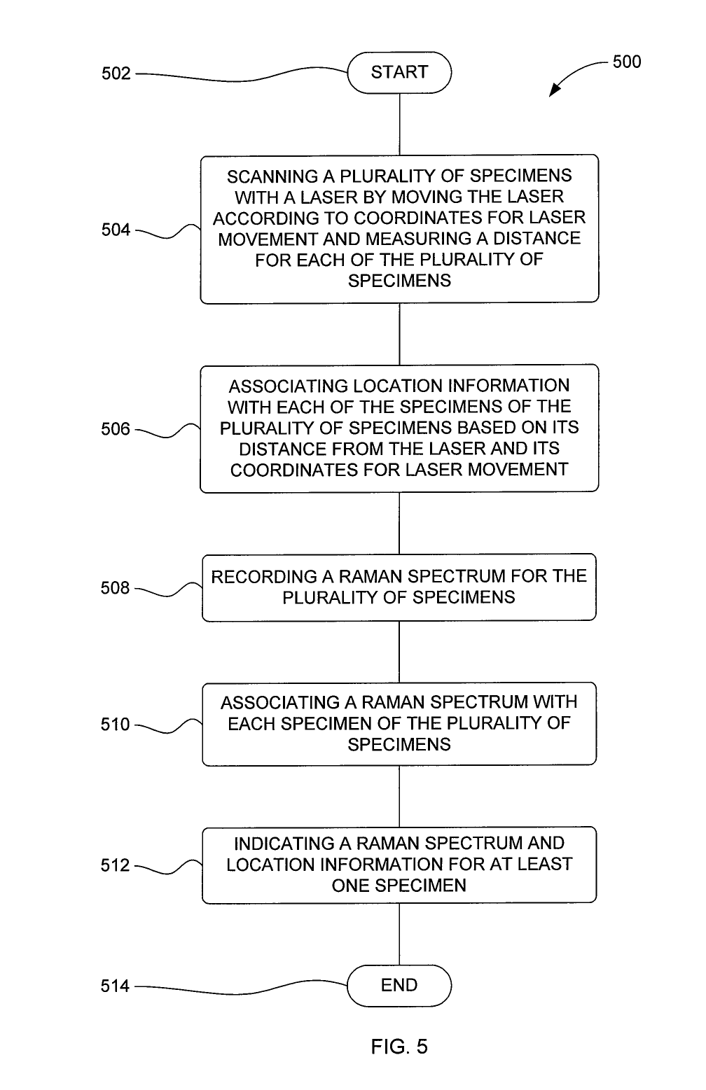

FIG. 5 illustrates a method, according to some embodiments. The illustrated method starts at 502. At 504, the method includes scanning a plurality of specimens with a laser by moving the laser according to coordinates for laser movement and measuring a distance for each of the plurality of specimens. At 506, the method includes associating location information with each of the specimens of the plurality of specimens based on its distance from the laser and its coordinates for laser movement. At 508, the method includes recording a Raman spectrum for the plurality of specimens. At 510, the method includes associating a Raman spectrum with each specimen of the plurality of specimens. At 512, the method includes indicating a Raman spectrum and location information for at least one specimen.

Various optional methods are possible. Some method embodiments include associating the Raman spectrum with a composition and indicating the composition of the specimen. Some embodiments include recording the Raman spectrum by exciting the specimen with the laser. Various embodiments include indicating a map including a plurality of specimens and respective composition and location information for each specimen. Some embodiments include scanning an area around a specimen, recording a plurality of Raman spectrum during the scan, and indicating a composition based on a statistical analysis of the plurality of Raman spectrum. Some embodiments include positioning the laser in a specified area via a self-powered vehicle. Additional embodiments include automatically scanning the plurality of specimens according to predetermined coordinates for laser movement. Still further embodiments include manually controlling the scanning and indicating a Raman spectrum and corresponding location for each specimen concurrent to the manual control. Additional embodiments include displaying a picture of the specimen concurrent to the manual control. Also, some embodiments include displaying a visible laser incident unto the specimen. Some embodiments display composition information concurrent with location. Methods including combinations of the optional methods are possible.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A method, comprising:
scanning a plurality of specimens with a laser by moving the laser according to specified coordinates for laser movement and measuring a distance to each of the plurality of specimens from the laser source;
associating location information with each of the specimens of the plurality of specimens based on its distance from the laser and its coordinates for laser movement;
recording a Raman spectrum for each of the plurality of specimens;
associating a Raman spectrum with each specimen of the plurality of specimens; and
indicating a Raman spectrum and location information for at least one specimen.

2. The method of claim 1, further comprising associating the Raman spectrum with a composition and indicating the composition of the specimen.

3. The method of claim 1, further comprising recording the Raman spectrum by exciting the specimen with the laser.

4. The method of claim 1, further comprising indicating a map including a plurality of specimens and respective composition and location information for each specimen.

5. The method of claim 4, further comprising recording an image of one or more specimens and indicating the image.

6. The method of claim 1, further comprising adjusting the Raman spectrum by adjusting at least one of a group including collection optics, focusing optics, laser power of the laser, slit width, integration time of a photo-detector and signal averages.

7. The method of claim 1, further comprising scanning an area around a specimen, recording a plurality of Raman spectrum during the scan, and indicating a composition based on a statistical analysis of the plurality of Raman spectrum.

8. The method of claim 1, further comprising positioning the laser in a specified an area via a self-powered vehicle.

9. The method of claim 1, further comprising automatically scanning the plurality of specimens according to predetermined coordinates for laser movement.

10. The method of claim 1, further comprising manually controlling the scanning and indicating a Raman spectrum and corresponding location for each specimen concurrent to the manual control.

11. The method of claim 10, further comprising displaying a picture of the specimen concurrent to the manual control.

12. The method of claim 11, further comprising displaying a visible laser incident unto the specimen.

13. An apparatus, comprising:
a Raman spectrometer to measure a Raman spectrum of at least one of a plurality of specimens;
a distance measuring device coupled to the Raman spectrometer to optically determine distance to the at least one specimen;
a scanning mechanism coupled to the Raman spectrometer to align the Raman spectrometer and the distance measuring device with each of the plurality of specimens; and
an interface to display a location and a Raman spectrum for the at least one specimen.

14. The apparatus of claim 13, further comprising a composition information circuit coupled to Raman spectrometer to associate the Raman spectrum with a specified composition.

15. The apparatus of claim 13, wherein the scanning mechanism includes a gimbal.

16. The apparatus of claim 13, further comprising a battery to power the Raman spectrometer, the distance measuring device, the scanning mechanism and the interface, with the Raman spectrometer, the distance measuring device, and the battery each disposed in a housing.

17. An apparatus, comprising:
a Raman spectrometer, comprising:
a laser;
a slit coupled to the laser and aligned with a laser path of the laser;
a grating aligned with the laser path of the laser;
a photo-detector array aligned with the laser path of the laser; and
optics aligned with the laser path of the laser; and
an interface to display a location and a Raman spectrum for at least one specimen;
a range finding laser that is visible coupled to the Raman spectrometer to optically determine distance to the at least one specimen; and
a housing and a battery to power the Raman spectrometer, the range finding laser, and the interface, with the Raman spectrometer, the distance measuring device, and the battery each disposed in the housing.

18. The apparatus of claim 17, wherein the laser includes an ultraviolet laser.

19. The apparatus of claim 17, wherein the housing is coupled to a scanner to position the housing in alignment with a plurality of specimens including the at least one specimen.

20. The apparatus of claim 17, further comprising a collimating lens aligned with the path of the laser.
